(19) United States
(12) Patent Application Publication
(10) Pub. No.: US 2024/0338448 A1
(43) Pub. Date: Oct. 10, 2024

(54) APPARATUS AND METHOD FOR PROCESSING DATA UNITS

(71) Applicant: Robert Bosch GmbH, Stuttgart (DE)

(72) Inventors: Herbert Leuwer, Langballig (DE); Michael Buchalik, Breisach (DE)

(21) Appl. No.: 18/293,264

(22) PCT Filed: Aug. 23, 2022
(86) PCT No.: PCT/EP2022/073410

§ 371 Date: Jan. 29, 2024

(30) Foreign Application Priority Data
Aug. 25, 2021 (DE) 10 2021 209 322.1

(51) Int. Cl. G06F 21/56; H04L 69/327

(52) U.S. Cl. CPC G06F 21/566; G06F 2221/034; H04L 69/327

(57) ABSTRACT

An apparatus for processing data units, e.g., protocol data units. The apparatus includes a first number of input interfaces for receiving protocol data units and, optionally, a second number of output interfaces for outputting protocol data units, and a checking device, e.g., a firewall device, which is designed to check at least one received protocol data unit, e.g., to subject it to a security check.

### FIELD

The present invention relates to an apparatus for processing data units.

The present invention also relates to a method for processing data units.

### SUMMARY

Exemplary embodiments of the present invention relate to an apparatus for processing data units, e.g., protocol data units, comprising a first number of input interfaces for receiving protocol data units and, optionally, a second number of output interfaces for outputting protocol data units, and a checking device, e.g., a firewall device, which is designed to check at least one received protocol data unit, e.g., to subject it to a security check.

In further exemplary embodiments of the present invention, the first number is greater than or equal to one. In further exemplary embodiments, the second number is greater than or equal to one.

In further exemplary embodiments of the present invention, it is provided that the checking device is designed as a hardware circuit, e.g., a pure hardware circuit. This enables an efficient hardware-based check, for example according to specifiable (and/or learnable) firewall rules or security rules, for example with respect to protocol data units that can potentially be processed by the apparatus. In addition, software-based attacks on the hardware checking device or hardware firewall are ineffective.

In further exemplary embodiments of the present invention, it is provided that the checking device is designed to selectively test the at least one received protocol data unit, for example on the basis of a first item of control information, e.g., a bit flag. In other words, the checking device can, for example, test received protocol data units temporarily, for example on the basis of the control information, which can, for example, be provided by another component of the apparatus, and the checking device can, for example, temporarily not perform any check of protocol data units. In further exemplary embodiments, a control whether, for example, a particular protocol data unit, e.g., a protocol data unit corresponding to at least one specifiable criterion, is to be tested can, for example, be carried out by the apparatus or another component of the apparatus (other than the checking device). Alternatively, or additionally, a control whether, for example, a particular protocol data unit is to be tested can be carried out by the checking device.

In further exemplary embodiments of the present invention, it is provided that the checking device is designed to test at least some received protocol data units, e.g., all received protocol data units.

In further exemplary embodiments of the present invention, it is provided that the checking device is designed to check protocol data units associated with at least one protocol, e.g., at least one service-oriented protocol, which works in layer 5 of the ISO/OSI reference model, e.g., protocol data units associated with a scalable service-oriented middleware over IP, SOME/IP, protocol.

In further exemplary embodiments of the present invention, it is provided that the checking device is designed to ascertain a message type of at least one SOME/IP message associated with the at least one received protocol data unit, wherein the message type, for example, comprises at least one of the following elements: a) REQUEST, b) REQUEST_NO_RETURN, c) NOTIFICATION, d) RESPONSE, e) ERROR, f) TP_REQUEST, g) TP_REQUEST_NO_RETURN, h) TP_NOTIFICATION, i) TP_RESPONSE, j) TP_ERROR.

In further exemplary embodiments of the present invention, it is provided that the checking device is designed to ascertain a service type of at least one SOME/IP message associated with the at least one received protocol data unit, wherein the service type, for example, comprises at least one of the following elements: a) RPC, remote procedure call, b) Fire & Forget, c) Notify.

In further exemplary embodiments of the present invention, it is provided that the checking device is designed to perform a condition-based and/or condition-oriented evaluation of at least one SOME/IP service, e.g., of remote procedure calls, for example comprising request elements and/or response elements, for example on the basis of the at least one received protocol data unit.

In further exemplary embodiments of the present invention, it is provided that the checking device is designed to also perform, at least temporarily, non-condition-based and/or non-condition-oriented evaluations, for example of SOME/IP services.

In further exemplary embodiments of the present invention, it is provided that the checking device is designed to discard the at least one received protocol data unit, for example on the basis of the check, for example if a result of the check is indicative of an attack attempt or a malicious data unit.

In further exemplary embodiments of the present invention, it is provided that the checking device is designed to not discard the at least one received protocol data unit, for example to forward it, for example for an output, for example to another unit, for example on the basis of the check, for example if a result of the check is not indicative of an attack attempt or a malicious data unit.

In further exemplary embodiments of the present invention, it is provided that the checking device is designed to modify or to influence the at least one received protocol data unit and/or an output of the at least one received protocol data unit, for example via an output interface, for example in order to cause a unicast output or a multicast output.

In further exemplary embodiments of the present invention, it is provided that the checking device is designed to perform at least one of the following elements: a) attack detection, e.g., intrusion detection, and/or attack detection and attack prevention, e.g., intrusion detection and prevention, b) labeling the at least one received protocol data unit, for example on the basis of the check and/or on the basis of a result of the check, c) outputting and/or forwarding the at least one received protocol data unit, for example by means of a multicast mechanism, for example to at least one software component, for example for, for example further, evaluation or performance of a, for example software-based, attack detection, d) outputting and/or forwarding the at least one received protocol data unit, for example by means of a unicast mechanism, for example to at least one software component or the at least one software component, for example for, for example further, evaluation or performance of a, for example software-based, attack detection, e) ascertaining and/or evaluating messages for service detection, e.g., service discovery messages, which are, for example, based on a, for example connectionless, network protocol, e.g., on a user datagram protocol, UDP, f) ascertaining and/or evaluating protocol data unit of the AUTOSAR I-PDU type, for example for a check, e.g., a security check.

In further exemplary embodiments of the present invention, it is provided that the apparatus comprises a processing device, which is designed to perform, on the basis of a PDU identifier associated with a received protocol data unit, a search in at least a first search tree comprising an allocation of in each case one PDU identifier to a connection identifier characterizing at least one data connection, wherein the search can, for example, be performed before and/or after and/or with an at least partial time overlap with the check. In further exemplary embodiments, the search can, for example, be used for routing, e.g., forwarding, the data unit.

In further exemplary embodiments of the present invention, if, for example, the check takes place before the search, the search can, for example, be performed on the basis of a result of the check.

In further exemplary embodiments of the present invention, if, for example, the check takes place after the search, the check can, for example, be performed on the basis of a result of the search, e.g., on the basis of the connection identifier, and/or on the basis of information associated with the connection identifier. In further exemplary embodiments, it can thus, for example, be achieved that, for particular connection identifiers, a check of the relevant data units is performed by means of the checking device, wherein, for other connection identifiers, no check of the relevant data units is, for example, performed by means of the checking device.

In further exemplary embodiments of the present invention, it is provided that the apparatus is designed to ascertain, on the basis of the received protocol data unit, a connection identifier associated with the received protocol data unit, wherein the ascertainment can, for example, be performed before and/or after and/or with an at least partial time overlap with the check.

In further exemplary embodiments of the present invention, it is provided that the processing device comprises at least one hardware component designed to perform the search in the first search tree and/or to ascertain the connection identifier associated with the received protocol data unit. The hardware-based search can, for example, take place particularly fast and efficiently and, just like a hardware-based (firewall) check of data units, is insensitive to software-based attack attempts.

In further exemplary embodiments of the present invention, it is provided that the first search tree is a binary tree.

In further exemplary embodiments of the present invention, it is provided that the processing device comprises at least one software component, wherein the software component is designed to perform at least one of the following elements: a) at least temporarily forming the first search tree, b) at least temporarily modifying, e.g., balancing, the first search tree, c) receiving the at least one protocol data unit from the checking device (e.g., if, on the basis of the result of the check of the protocol data unit, the checking device concludes that a, for example further, software-based check of the protocol data unit is to take place), d) evaluating, e.g., performing a, for example software-based, attack detection.

In further exemplary embodiments of the present invention, it is provided that the at least one software component is designed to perform a specifiable response if no connection identifier associated with the received protocol data unit can be ascertained for the received protocol data unit, e.g., if no connection identifier associated with the received protocol data unit is present for the received protocol data unit in the first search tree, wherein the specifiable response, for example, comprises at least one of the following elements: a) discarding the received protocol data unit, b) assigning a, for example configurable, connection identifier to the received protocol data unit, c) setting or inserting a first item of information and/or a first item of control information for the received protocol data unit, for example in the form of a bit flag, wherein the first item of information and/or the first item of control information, for example, indicates that the received protocol data unit is to be subjected to a check, for example by means of the checking device, e.g., the firewall device.

In further exemplary embodiments of the present invention, it is provided that the checking device is designed to evaluate the first item of information and/or the first item of control information and, on the basis thereof, to perform or not perform a check of the relevant data unit.

In further exemplary embodiments of the present invention, it is provided that the apparatus comprises at least one memory for at least temporarily storing one or more protocol data units or portions of one or more protocol data units.

In further exemplary embodiments of the present invention, it is provided that the apparatus comprises a conditioning device designed to change, e.g., normalize, a PDU identifier associated with a received protocol data unit.

In further exemplary embodiments of the present invention, it is provided that a data structure, e.g., a node structure, for the at least one search tree comprises an attribute that indicates whether a security check, for example by means of the checking device, is to be performed for a relevant protocol data unit or for protocol data units associated with a connection identifier. For example, the attribute may correspond to the first item of information or the first item of control information.

In further exemplary embodiments of the present invention, it is provided that the checking device is designed to use the connection identifier, for example for ascertaining a service and/or an identification associated with, for example, the at least one received protocol data unit.

Further exemplary embodiments of the present invention relate to a method, e.g., a computer-implemented method, for processing data units, e.g., protocol data units, for an apparatus, for example according to at least one of the preceding embodiments, comprising a first number of input interfaces for receiving protocol data units and, optionally, a second number of output interfaces for outputting protocol data units, and a checking device, e.g., a firewall device, which is designed to check at least one received protocol data unit, e.g., to subject it to a security check, wherein the method comprises: receiving at least one protocol data unit, checking the received at least one protocol data unit by means of the checking device.

In further exemplary embodiments of the present invention, it is provided that the method comprises at least one of the following elements: a) outputting the at least one protocol data unit, for example on the basis of the test, b) discarding the at least one protocol data unit, for example on the basis of the test.

In further exemplary embodiments of the present invention, it is provided that the checking device modifies or influences the at least one received protocol data unit and/or an output of the at least one received protocol data unit, for example via an output interface.

In further exemplary embodiments of the present invention, it is provided that the checking device performs at least one of the following elements: a) attack detection, e.g., intrusion detection, b) labeling the at least one received protocol data unit, for example on the basis of the check and/or on the basis of a result of the check, c) outputting and/or forwarding the at least one received protocol data unit, for example by means of a multicast mechanism, for example to at least one software component, for example for, for example further, evaluation or performance of a, for example software-based, attack detection, d) outputting and/or forwarding the at least one received protocol data unit, for example by means of a unicast mechanism, for example to at least one software component or the at least one software component, for example for, for example further, evaluation or performance of a, for example software-based, attack detection, e) ascertaining and/or evaluating messages for service detection, e.g., service discovery messages, which are, for example, based on a, for example connectionless, network protocol, e.g., on a user datagram protocol, UDP, f) ascertaining and/or evaluating protocol data unit of the AUTOSAR I-PDU type, for example for a check, e.g., a security check.

Further exemplary embodiments of the present invention relate to an apparatus for performing the method according to the embodiments.

Further exemplary embodiments of the present invention relate to a computer-readable storage medium comprising instructions that, when executed by a computer, cause the latter to perform at least some steps of the method according to the embodiments.

Further exemplary embodiments of the present invention relate to a computer program comprising instructions that, when the program is executed by a computer, cause the latter to perform at least some steps of the method according to the embodiments.

Further exemplary embodiments of the present invention relate to a data carrier signal that transmits and/or characterizes the computer program according to the embodiments.

Further exemplary embodiments of the present invention relate to a gateway, e.g., an automotive gateway, comprising at least one device according to the embodiments.

Further exemplary embodiments of the present invention relate to a use of the apparatus according to the embodiments and/or of the method according to the embodiments and/or of the computer-readable storage medium according to the embodiments and/or of the computer program according to the embodiments and/or of the data carrier signal according to the embodiments and/or of the gateway according to the embodiments for at least one of the following elements: a) processing data units, e.g., protocol data units, for example of a vehicle, e.g., a motor vehicle, b) ascertaining, e.g., searching for, for example by means of a hardware component, a connection identifier associated with a received protocol data unit, c) managing at least one search tree, d) performing a hardware-based search for a connection identifier for a data unit, e.g., a protocol data unit, for example for a gateway for automotive applications, wherein the search can, for example, be performed with logarithmic effort, e) routing or forwarding data units, e.g., protocol data units, for example of a vehicle, e.g., a motor vehicle, wherein the data units can, for example, be of different types, f) assigning a, for example protocol-independent, connection identifier, g) performing multicast transmissions, h) ascertaining whether no connection identifier is provided, e.g., stored, e.g., contained in the search tree, for a specifiable received data unit, e.g., a protocol data unit, i) software-based processing of a received data unit, e.g., a protocol data unit, for which no connection identifier is provided, e.g., stored, e.g., contained in the search tree, j) checking the at least one received protocol data unit, e.g., performing a security check, k) hardware-based firewall test of protocol data units associated with at least one protocol, e.g., at least one service-oriented protocol, which works in layer 5 of the ISO/OSI reference model, e.g., protocol data units associated with a scalable service-oriented middleware over IP, SOME/IP, protocol, l) selectively applying routing functions, e.g., forwarding functions, and/or firewall functions to protocol data units.

Further features, possible applications, and advantages of the present invention emerge from the following description of exemplary embodiments of the present invention, which are shown in the figures. All described or depicted features by themselves or in any combination constitute the subject matter of the present invention, regardless of their formulation or representation in the description or in the figures.

### BRIEF DESCRIPTION OF THE DRAWINGS

FIG. 1 schematically shows a simplified block diagram according to exemplary embodiments of the present invention.

FIG. 2 schematically shows a simplified flow chart according to exemplary embodiments of the present invention.

FIG. 3 schematically shows a simplified flow chart according to exemplary embodiments of the present invention.

FIG. 4 schematically shows a simplified flow chart according to exemplary embodiments of the present invention.

FIG. 5 schematically shows a simplified flow chart according to exemplary embodiments of the present invention.

FIG. 6 schematically shows a simplified block diagram according to exemplary embodiments of the present invention.

FIG. 7 schematically shows a simplified block diagram according to exemplary embodiments of the present invention.

FIG. 8 schematically shows a simplified block diagram according to exemplary embodiments of the present invention.

FIG. 9 schematically shows a simplified flow chart according to exemplary embodiments of the present invention.

FIG. 10 schematically shows a simplified flow chart according to exemplary embodiments of the present invention.

FIG. 11 schematically shows a simplified flow chart according to exemplary embodiments of the present invention.

FIG. 12 schematically shows a simplified flow chart according to exemplary embodiments of the present invention.

FIG. 13 schematically shows a simplified flow chart according to exemplary embodiments of the present invention.

FIG. 14 schematically shows a simplified flow chart according to exemplary embodiments of the present invention.

FIG. 15 schematically shows a simplified block diagram according to exemplary embodiments of the present invention.

FIG. 16 schematically shows a simplified flow chart according to exemplary embodiments of the present invention.

FIG. 17 schematically shows a simplified flow chart according to exemplary embodiments of the present invention.

FIG. 18 schematically shows a simplified block diagram according to exemplary embodiments of the present invention.

FIG. 19 schematically shows a simplified block diagram according to exemplary embodiments of the present invention.

FIG. 20 schematically shows a simplified flow chart according to exemplary embodiments of the present invention.

FIG. 21 schematically shows a simplified block diagram according to exemplary embodiments of the present invention.

FIG. 22 schematically shows a simplified block diagram according to exemplary embodiments of the present invention.

FIG. 23 schematically shows aspects of uses according to exemplary embodiments of the present invention.

### DETAILED DESCRIPTION OF EXAMPLE EMBODIMENTS

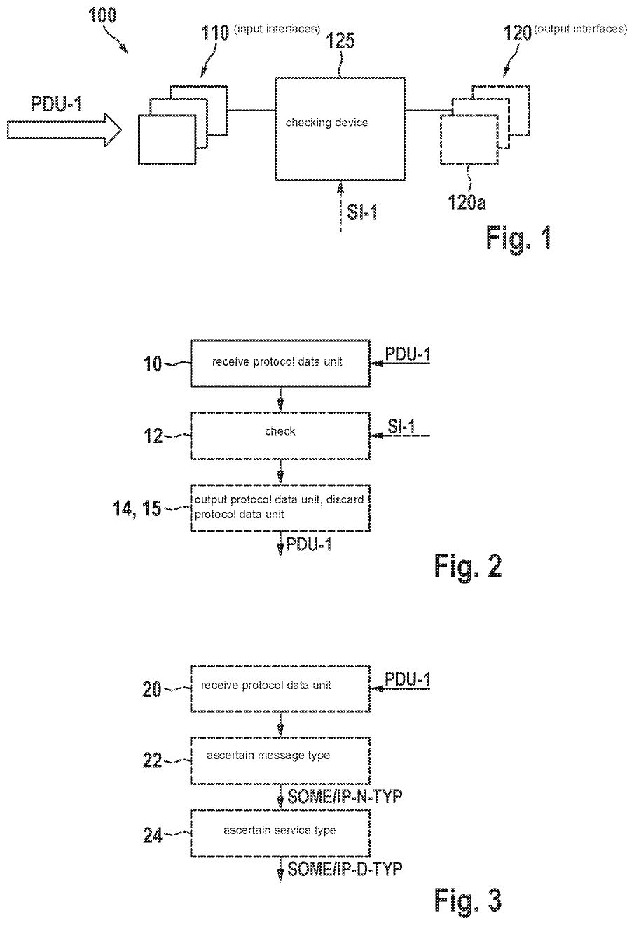

Exemplary embodiments, FIG. 1, relate to an apparatus 100 for processing data units PDU-1, e.g., protocol data units, comprising a first number of input interfaces 110 for receiving protocol data units PDU-1 and, optionally, a second number of output interfaces 120 for outputting protocol data units, and a checking device 125, e.g., a firewall device (hereinafter “firewall” for short), which is designed to check at least one received protocol data unit PDU-1, e.g., to subject it to a security check.

In further exemplary embodiments, the first number is greater than or equal to one. In further exemplary embodiments, the second number is greater than or equal to one.

A flow chart of a corresponding method according to exemplary embodiments is shown in FIG. 2, wherein block 10 symbolizes the reception of the at least one protocol data unit PDU-1, and wherein block 12 symbolizes an optional check. By way of example, block 14, 15 symbolizes an optional further operation of the apparatus 100, for example on the basis of the check 12.

In further exemplary embodiments, it is provided that the checking device 125 is designed as a hardware circuit, e.g., a pure hardware circuit, i.e., for example, does not comprise any software. This enables an efficient hardware-based check 12, for example according to specifiable (and/or learnable or (fixedly) programmable) firewall rules or security rules, for example with respect to protocol data units PDU-1 that can potentially be processed by the apparatus 100. In addition, software-based attacks on the hardware checking device 125 or hardware firewall are ineffective.

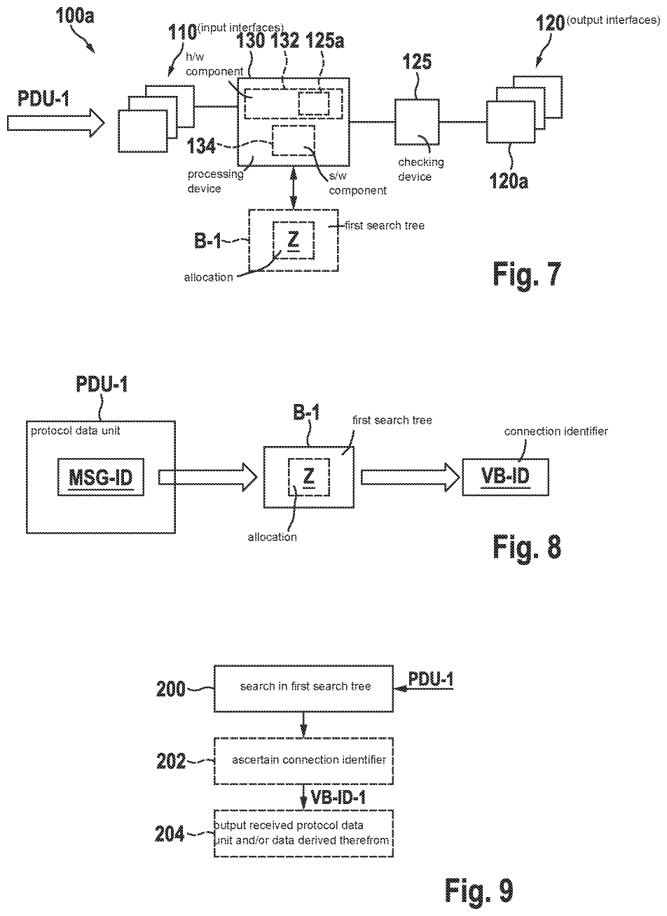

In further exemplary embodiments, it is provided that the checking device 125 (FIG. 1) is designed to selectively test the at least one received protocol data unit PDU-1, for example on the basis of a first item of control information SI-1, e.g., a bit flag or characterizable by a bit flag. In other words, the checking device 125 can, for example, test received protocol data units PDU-1 temporarily, for example on the basis of the control information SI-1, which can, for example, be provided by another component 130 (see below, FIG. 7) of the apparatus 100, and the checking device 125 can, for example, temporarily not perform any check of protocol data units. In further exemplary embodiments, a control whether, for example, a particular protocol data unit, e.g., a protocol data unit corresponding to at least one specifiable criterion, is to be tested can, for example, be carried out by the apparatus 100 or another component 130 (FIG. 7) of the apparatus (other than the checking device 125). Alternatively, or additionally, a control whether, for example, a particular protocol data unit is to be tested can be carried out by the checking device 125 itself.

In further exemplary embodiments, it is provided that the checking device 125 is designed to test at least some received protocol data units PDU-1, e.g., all received protocol data units.

In further exemplary embodiments, it is provided that the checking device 125 is designed to check protocol data units associated with at least one protocol, e.g., at least one service-oriented protocol, which works in layer 5 of the ISO/OSI reference model, e.g., protocol data units associated with a scalable service-oriented middleware over IP, SOME/IP, protocol.

In further exemplary embodiments, it is provided that the checking device 125 is designed to (also) test data units associated with other, possibly higher or lower, ISO/OSI layers.

In further exemplary embodiments, FIG. 3, it is provided that the checking device 125 is designed to ascertain 22 a message type SOME/IP-N-TYP of at least one SOME/IP message associated with the at least one received protocol data unit PDU-1, wherein the message type SOME/IP-N-TYP, for example, comprises at least one of the following elements: a) REQUEST, b) REQUEST_NO_RETURN, c) NOTIFICATION, d) RESPONSE, e) ERROR, f) TP_REQUEST, g) TP_REQUEST NO RETURN, h) TP_NOTIFICATION, i) TP_RESPONSE, j) TP_ERROR. Optional block 20 according to FIG. 3 symbolizes a reception of the protocol data unit PDU-1, for example similarly to block 10 according to FIG. 2.

In further exemplary embodiments, it is provided that the checking device 125 is designed to ascertain 24 a service type SOME/IP-D-TYP of at least one SOME/IP message associated with the at least one received protocol data unit PDU-1, wherein the service type SOME/IP-D-TYP, for example, comprises at least one of the following elements: a) RPC, remote procedure call, b) Fire & Forget, c) Notify.

In further exemplary embodiments, block 22 according to FIG. 3 and/or block 24 according to FIG. 3 can, for example, be part of the check 12 according to FIG. 2.

In further exemplary embodiments, FIG. 4, it is provided that the checking device 125 (FIG. 1) is designed to perform 28 (FIG. 4) a condition-based and/or condition-oriented evaluation of at least one SOME/IP service, e.g., of remote procedure calls, for example comprising request elements and/or response elements, for example on the basis of the at least one received protocol data unit PDU-1, cf. block 26 according to FIG. 4, which, by way of example, symbolizes the reception of the protocol data unit PDU-1.

In further exemplary embodiments, it is provided that the checking device 125 is designed to also perform, at least temporarily, non-condition-based and/or non-condition-oriented evaluations, for example of SOME/IP services and/or other services and/or protocols, or the data units associated therewith.

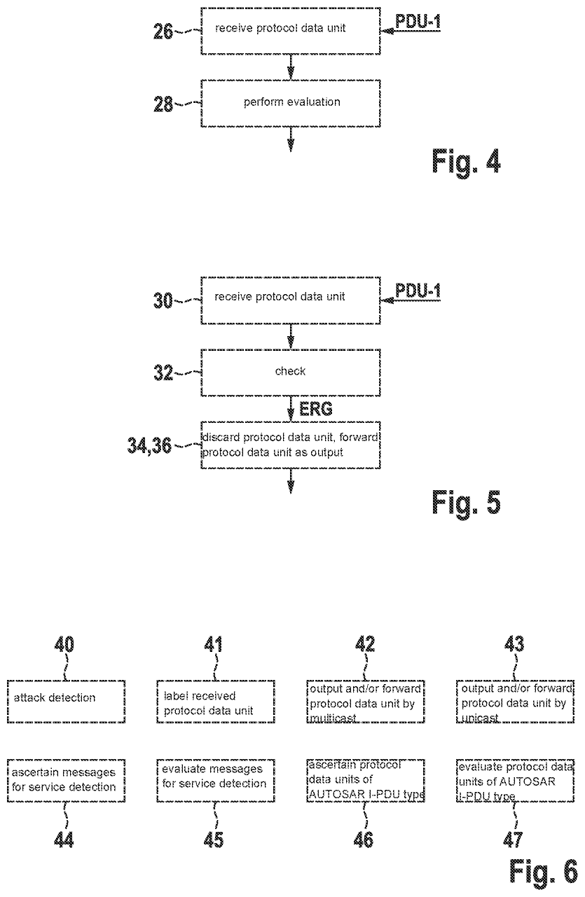

In further exemplary embodiments, FIG. 5, it is provided that the checking device 125 is designed to discard 34 the at least one received protocol data unit PDU-1, for example on the basis of the check 32, for example if a result ERG of the check 32 is indicative of an attack attempt or a malicious data unit.

In further exemplary embodiments, it is provided that the checking device 125 is designed to not discard the at least one received protocol data unit PDU-1, for example to forward 36 it, for example for an output (see, for example, element 120, 120a according to FIG. 1), for example to another unit, for example on the basis of the check 32, for example if a result ERG of the check 32 is not indicative of an attack attempt or a malicious data unit. Optional block 30 according to FIG. 5, by way of example, symbolizes the reception of the protocol data unit PDU-1.

In further exemplary embodiments, it is provided that the checking device 125 is designed to modify or to influence the at least one received protocol data unit PDU-1 and/or an output of the at least one received protocol data unit, for example via an output interface 120a (FIG. 1), for example in order to cause a unicast output or a multicast output.

In further exemplary embodiments, FIG. 6, it is provided that the checking device 125 is designed to perform at least one of the following elements: a) attack detection 40, e.g., intrusion detection, and/or attack detection and attack prevention, e.g., intrusion detection and prevention, b) labeling 41 the at least one received protocol data unit PDU-1, for example on the basis of the check 12, 32 and/or on the basis of a result ERG of the check, c) outputting and/or forwarding 42 the at least one received protocol data unit PDU-1 by means of a multicast mechanism, for example to at least one software component 134 (see below, FIG. 7), for example for, for example further, evaluation or performance of a, for example software-based, attack detection, d) outputting and/or forwarding 43 the at least one received protocol data unit PDU-1 by means of a unicast mechanism, for example to at least one software component or the at least one software component 134, for example for, for example further, evaluation or performance of a, for example software-based, attack detection, e) ascertaining 44 and/or evaluating 45 messages for service detection, e.g., service discovery messages, which are, for example, based on a, for example connectionless, network protocol, e.g., on a user datagram protocol, UDP, f) ascertaining 46 and/or evaluating 47 protocol data units of the AUTOSAR I-PDU type, for example for a check, e.g., a security check.

In further exemplary embodiments, cf. FIGS. 7, 8, 9, it is provided that the apparatus 100a comprises a processing device 130, which is designed to perform, on the basis of a PDU identifier associated with a received protocol data unit PDU-1, a search 200 (FIG. 9) in at least a first search tree B-1 (FIGS. 7, 8) comprising an allocation Z of in each case one PDU identifier MSG-ID to a connection identifier VB-ID characterizing at least one data connection, wherein the search 200 can, for example, be performed before and/or after and/or with an at least partial time overlap with the check 12 (FIG. 2). In further exemplary embodiments, the search 200 can, for example, be used for routing, e.g., forwarding, the data unit.

In further exemplary embodiments, if, for example, the check 12 takes place before the search 200, the search 200 can, for example, be performed on the basis of a result ERG of the check 12.

In further exemplary embodiments, if, for example, the check 12 takes place after the search 200, the check 12 can, for example, be performed on the basis of a result ERG of the search, e.g., on the basis of the connection identifier VB-ID, and/or on the basis of information associated with the connection identifier VB-ID. In further exemplary embodiments, it can thus, for example, be achieved that, for particular connection identifiers, a check 12 of the relevant data units PDU-1 is performed by means of the checking device 125, wherein, for other connection identifiers, no check of the relevant data units is, for example, performed by means of the checking device 125.

In further exemplary embodiments, it is provided that the apparatus 100a is designed to ascertain 202 (FIG. 9), on the basis of the received protocol data unit PDU-1, a connection identifier VB-ID associated with the received protocol data unit PDU-1, wherein the ascertainment 202 can, for example, be performed before and/or after and/or with an at least partial time overlap with the check 12.

In further exemplary embodiments, it is provided that the processing device 130 comprises at least one hardware component 132, which is designed to perform the search 200 in the first search tree B-1 and/or to ascertain 202 the connection identifier VB-ID associated with the received protocol data unit PDU-1. The hardware-based search can, for example, take place particularly fast and efficiently and, just like a hardware-based (firewall) check 12 of data units, is insensitive to software-based attack attempts.

In further exemplary embodiments, it is provided that the first search tree B-1 is a binary tree.

In further exemplary embodiments, it is provided that the first search tree B-1 is a ternary or n-nary, n>3, tree.

In further exemplary embodiments, it is provided that the apparatus 100a is designed to output, on the basis of the connection identifier VB-ID-1 associated with the received protocol data unit PDU-1, the received protocol data unit PDU-1 and/or data that can be or are derived therefrom to at least one particular output interface 120a (FIGS. 1, 7) of the second number of output interfaces 120, cf. optional block 204 according to FIG. 9.

In further exemplary embodiments, it is provided that at least a portion of the functionality of the checking device 125 is realized by means of the hardware component 132, cf. element 125a according to FIG. 7. In further exemplary embodiments, the checking device 125 can also be fully integrated into the hardware component 132.

In further exemplary embodiments, the checking device 125 can also be designed and/or arranged separately from the hardware component 132 of the processing device 130.

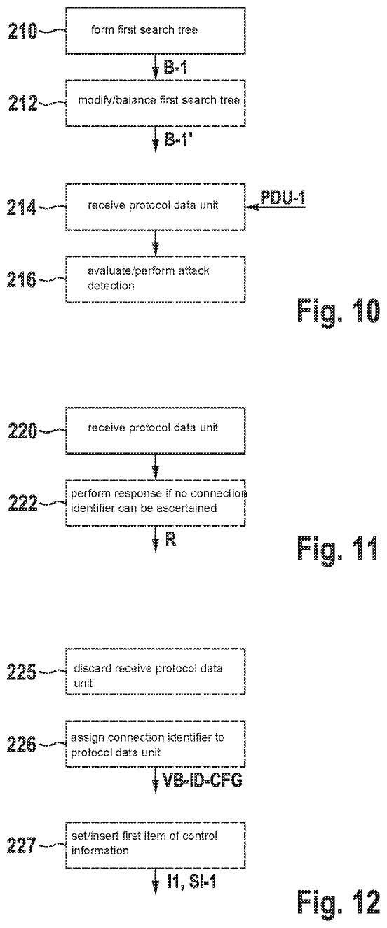

In further exemplary embodiments, it is provided that the processing device 130 comprises at least one software component 134, wherein the software component 134 is designed to perform at least one of the following elements: a) at least temporarily forming 210 (FIG. 10) the first search tree B-1, b) at least temporarily modifying, e.g., balancing, 212 the first search tree B-1, wherein a balanced first search tree B-1′ is, for example, obtained, c) receiving 214 the at least one protocol data unit PDU-1 from the checking device 125 (e.g., if, on the basis of the result ERG of the check 12, 32 of the protocol data unit, the checking device 125 concludes that a, for example further, software-based check of the protocol data unit is to take place), d) evaluating 216, e.g., performing a, for example software-based, attack detection.

In further exemplary embodiments, FIGS. 11, 12, it is provided that the at least one software component 134 is designed to perform 222 a specifiable response R if no connection identifier associated with the received protocol data unit can be ascertained for the received protocol data unit PDU-1, e.g., if no connection identifier associated with the received protocol data unit is present for the received protocol data unit in the first search tree B-1, wherein the specifiable response R, for example, comprises at least one of the following elements: a) discarding 225 (FIG. 12) the received protocol data unit, b) assigning 226 a, for example configurable, connection identifier VB-ID-CFG to the received protocol data unit, c) setting or inserting 227 a first item of information I1 and/or a first item of control information SI-1 for the received protocol data unit, for example in the form of a bit flag, wherein the first item of information I1 and/or the first item of control information SI-1, for example, indicates that the received protocol data unit is to be subjected to a check 12, for example by means of the checking device 125, e.g., the firewall device. In further exemplary embodiments, block 220 according to FIG. 11 symbolizes a reception of the protocol data unit PDU-1.

In further exemplary embodiments, it is provided that the checking device 125 is designed to evaluate the first item of information I1 and/or the first item of control information SI-1 and, on the basis thereof, to perform or not perform a check 12 of the relevant data unit. For example, the checking device 125 can check the relevant data unit if a bit flag corresponding to the information I1, SI-1 is set, whereas the checking device 125 does not check the relevant data unit if a bit flag corresponding to the information I1, SI-1 is not set.

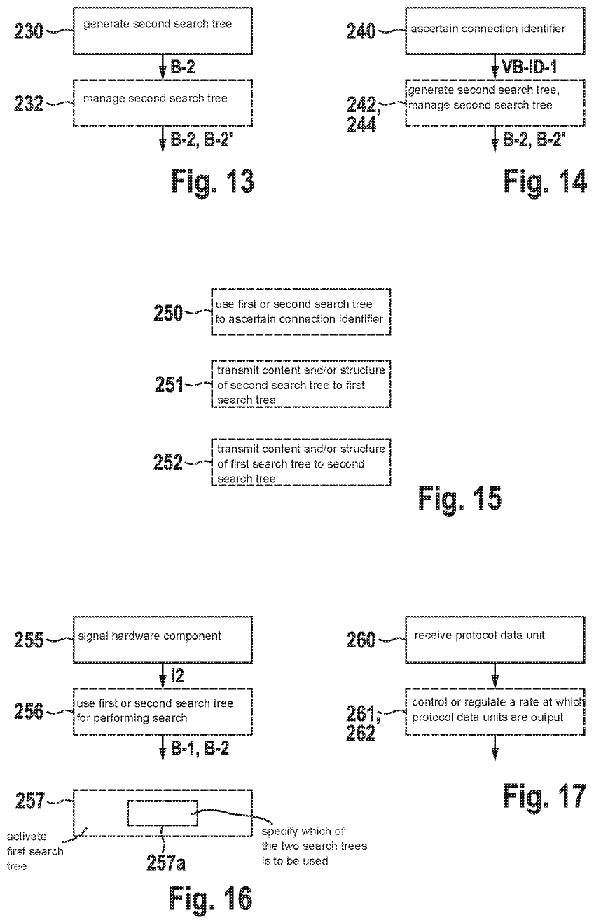

In further exemplary embodiments, FIG. 13, it is provided that the apparatus 100, 100a (FIGS. 1, 7), e.g., the at least one software component 134, is designed to generate 230 (FIG. 13), for example on the basis of the first search tree B-1, a second search tree B-2 and/or to manage 232 it, for example to modify it, wherein a modified second search tree B-2′ can, for example, be obtained.

In further exemplary embodiments, it is provided that the first search tree B-1 and/or the second search tree B-2 is a red-black tree.

In further exemplary embodiments, it is provided that the first search tree B-1 is a binary tree, for example without color information (e.g., red/black) and that the second search tree B-2 is a red-black tree. This enables an efficient, for example hardware-based, search, for example by means of the at least one hardware component 132, in the first search tree B-1, wherein no color information is, for example, available for the search, whereas, in further exemplary embodiments, for example for efficient management of the second search tree B-2, the second search tree B-2 is designed as a red-black tree.

In further exemplary embodiments, it is provided that the apparatus 100 is designed to organize the first search tree B-1 and/or the second search tree B-2 at least temporarily in the form of at least one table.

In further exemplary embodiments, FIG. 14, it is provided that the apparatus 100, 100a is designed to, in a manner at least partially overlapping in time, a) ascertain 240, on the basis of the received protocol data unit PDU-1, a connection identifier VB-ID-1 associated with the received protocol data unit PDU-1, for example by means of the at least one hardware component 132, for example by means of performing the search in the first search tree B-1 by the at least one hardware component 132, and b) generate 242, for example by means of the at least one software component 134, a or the second search tree B-2, for example on the basis of the first search tree B-1 (for example by copying the first search tree B-1), and/or to manage 244 it, for example to modify it (for example transforming it into a red-black tree and/or changing the elements or structure of the search tree).

In further exemplary embodiments, FIG. 15, it is provided that the apparatus 100, 100a is designed to perform at least one of the following elements: a) using 250 the first search tree B-1 or the second search tree B-2 at least temporarily, e.g., selectively, for example to ascertain the connection identifier VB-ID-1 associated with the received protocol data unit PDU-1, b) transmitting 251 a content and/or a structure of the second search tree B-2 to the first search tree B-1 (for example in order to make a search tree B-2, B-2′ that is modified, e.g., balanced, for example by means of the software component 134, in relation to the first search tree B-1, which can be searched, for example by means of the hardware component 132), c) transmitting 252 a content and/or a structure of the first search tree B-1 to the second search tree B-2 (for example in order to prepare a modification that can be performed, for example, by means of the software component 134).

In further exemplary embodiments, FIG. 16, it is provided that the apparatus 100, 100a, e.g., the at least one software component 134, is designed to signal 255, for example to the at least one hardware component 132, at least one of the following elements, for example by means of a second item of information I2: a) the first search tree B-1 is to be used for performing the search, b) the second search tree B-2 is to be used for performing the search, c) a modification of the first search tree B-1 and/or of the second search tree B-2, e.g., an insertion of at least one node and/or a balancing of the relevant search tree, has been completed.

In further exemplary embodiments, it is provided that the apparatus 100, e.g., the at least one hardware component 132, is designed to use 256, on the basis of the signaling 255, the first search tree B-1 or the second search tree B-2 for performing the search.

In further exemplary embodiments, it is provided that the apparatus 100, 100a, e.g., the at least one hardware component 132, is designed to activate 257 the first search tree B-1 or the second search tree B-2 for performing the search between two, for example successive, searches, for example for performing the search or searches in the future, for example by specifying 257a which of the two search trees is to be used from then on for performing the search or searches.

In further exemplary embodiments, FIG. 17, it is provided that the apparatus 100, 100a is designed to control 261 or to regulate 262 a rate at which protocol data units are output via at least one output interface of the second number of output interfaces. Block 260 in FIG. 17 symbolizes, for example, a reception of protocol data units for which said rate is controlled 261 or regulated 262 in further exemplary embodiments.

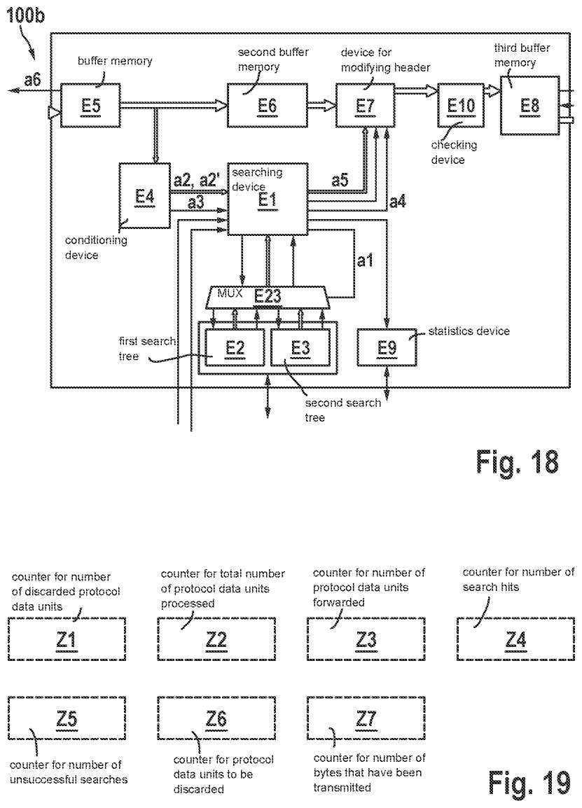

FIG. 18 schematically shows a simplified block diagram of an apparatus 100b according to exemplary embodiments, which in further exemplary embodiments can have a functionality comparable to the apparatus 100 according to FIG. 1 and/or to the apparatus 100a according to FIG. 7.

Block E1 according to FIG. 18 symbolizes a searching device, e.g., a searching device that can be implemented in the form of hardware, for example by means of or comparable to the hardware component 132 according to FIG. 7.

Block E2 symbolizes the first search tree B-1 (FIG. 7), e.g., a search tree that can be organized in the form of a first table, which can, for example, be referred to as a “work table” in further exemplary embodiments. Block E3 symbolizes the second search tree B-2 (FIG. 13), e.g., a search tree that can be organized in the form of a second table, which can, for example, be referred to as a “shadow table” in further exemplary embodiments.

In further exemplary embodiments, the apparatus 100b comprises a multiplexer device E23, via which the searching device E1 can, for example, selectively access the first table E2 or the second table E3, for example in order to perform a search, cf. block 200 according to FIG. 9. Selecting the first table E2 or the second table E3 can, for example, be realized in further exemplary embodiments by means of a control signal a1, which in further exemplary embodiments can, for example, be formed by the searching device E1 and/or output to the multiplexer device E23.

In further exemplary embodiments, it is provided that the apparatus 100b comprises at least one memory for at least temporarily storing one or more, for example received, protocol data units PDU-1 (FIG. 1) or portions of one or more protocol data units. The apparatus 100b comprises, for example, a first buffer memory E5, which can, for example, at least temporarily store, for example according to the FIFO (first in first out) principle, incoming protocol data units or protocol data units that can be received or are received by the apparatus 100b. Optionally, the first buffer memory E5 may also, at least temporarily, perform a desegmentation of received protocol data units.

In further exemplary embodiments, the apparatus 100b comprises a second buffer memory E6, which can be used, for example, for “delaying” at least one received protocol data unit, i.e., for example, for temporarily buffering the received protocol data unit or at least a portion of the received protocol data unit, for example until the protocol data unit is output, for example at a possibly specifiable later point in time.

In further exemplary embodiments, the second buffer memory E6 is designed to delay a received protocol data unit until the searching device E1 has ascertained the connection identifier VB-ID-1 associated with the received protocol data unit PDU-1, for example by a search performed in the first search tree B-1, E2, for example by means of the hardware component 132, E1.

In further exemplary embodiments, a storage capacity or storage size of the second buffer memory E6 can be specified on the basis of a maximum search duration in the first search tree B-1. For example, when using a binary first search tree B-1, it can be assumed in further exemplary embodiments that a maximum search duration is proportional to a logarithm, e.g., logarithm dualis (ld), of a number of nodes of the search tree and to a number of clock cycles required for reading and evaluating a node of the search tree.

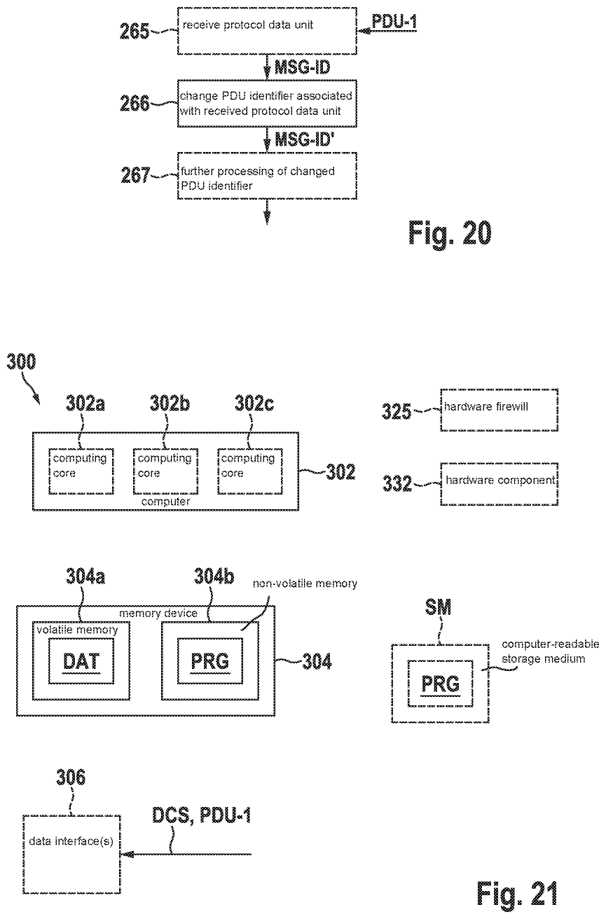

In further exemplary embodiments, it is provided that the apparatus 100b comprises a conditioning device E4 designed to change, e.g., normalize, a PDU identifier associated with a received protocol data unit. In this respect, FIG. 20 schematically shows a simplified flow chart according to further exemplary embodiments, wherein block 265 symbolizes an optional reception of a protocol data unit PDU-1, wherein block 266 symbolizes the change of a PDU identifier MSG-ID associated with a received protocol data unit, wherein a changed PDU identifier MSG-ID′ is, for example, obtained. The optional block 267 symbolizes a further processing of the changed PDU identifier MSG-ID′ according to further exemplary embodiments, e.g., a performance of a search in the first search tree B-1, E2 on the basis of the changed PDU identifier MSG-ID′.

In further exemplary embodiments, the conditioning device E4 is designed to form a search vector a2, which can, for example, be transmitted to the searching device E1.

In further exemplary embodiments, the search vector a2 can comprise at least one of the following elements: a) a PDU identifier MSG-ID associated with the received protocol data unit PDU-1, b) information rxbus characterizing a, for example virtual, input interface that corresponds, for example, to a virtual apparatus identification of a virtual apparatus via which the protocol data unit PDU-1 was received, c) information rembus characterizing, for example, for at least one type of received protocol data unit PDU-1, e.g., for an L-PDU type, a remote receive bus of the L-PDU.

In further exemplary embodiments, the search vector a2, also referred to as “searchVector,” can also, for example, comprise the three aforementioned elements a), b), c): searchVector={rxbus, rembus, msgid}, wherein msgid characterizes the PDU identifier MSG-ID.

In further exemplary embodiments, the searching device E1 is designed to compare the search vector a2 to reference vectors of the first table E2, wherein the reference vectors, for example, define a format or one of several possible formats.

In further exemplary embodiments, one or more of the following formats can be used for the PDU identifier MSG-ID, for example on the basis of a respective input interface 110, via which a protocol data unit PDU-1 was received: a) for example, protocol data units associated with a CAN (controller area network) protocol or CAN bus, for example of the type I-PDU (interaction layer protocol data unit, for example according to AUTOSAR), b) 11-bit standard ID, c) 29-bit extended ID, d) 32-bit message ID, for example of a CAN-XL acceptance field, e) I-PDUs associated with a LIN (local interconnect network) bus, f) AUTOSAR dynamic I-PDU multiplexing using UDP or CAN as transport layer (ASAR sockets in TUNETH_DEV or CAN sockets in TUNCAN_DEV), g) SomeIP S-PDU multiplexing (SomeIP socket in TUNETH_DEV or CAN sockets in TUNCAN_DEV), h) AVTP P1722 L-PDU multiplexing (AVB socket in TUNETH_DEV).

In further exemplary embodiments, the conditioning device E4 is designed to form a, for example compatible, search vector a2, for example by normalizing the aforementioned formats for the PDU identifier MSG-ID, wherein a normalized search vector a2′ is, for example, obtained. For example, the search vector a2 and/or the normalized search vector a2 can have 32 bits.

In further exemplary embodiments, a function of the conditioning device E4 can, for example, be characterized by the following pseudocode (“pseudocode 1”).

```
******** Pseudocode 1 - START ********
-- copy receive bus into search vector
searchVector.rxbus = tlv.rxbus
-- CAN I-PDU input
If tlv.messageType == CLF_TLV_CAN_DATA then
  searchVector.rembus = 0
  noSearch = false
  validMsg=true
  If tlv.word64[4].XDAT == 1 then
    -- CAN-XL
    searchVector.msgid = tlv.word64{5] & 0xFFFFFFFF00000000
  else
    -- standard CAN and CAN-FD If tlv.word64[4].EXT == 1 then
    SearchVector.msgid = tlv.word64[4] & 0x000000003FFF0000
  else
    SearchVector.msgid = tlv.word64[4] & 0x000000001FFFFFFF
  end
end
-- LIN I-PDU input
elseif tlv.messageType == CLF_TLV_LIN_DATA then
  searchVector.rembus = 0
  searchVector.msgid = tlv.word64[4] & 0x3F
  noSearch = false
-- AUTOSAR I-PDU multiplex input with LONG ID or
-- SomeIP S-PDU multiplex input with LONG ID
elseif tlv.messageType == CLF_TLV_PDU_LONG then
  searchVector.rembus = 0
  searchVector.msgid = tlv.word64[5] & 0x00000000FFFFFFFF
  noSearch = false
-- AUTOSAR I-PDU multiplex input with SHORT ID
elseif tlv.messageType == CLF_TLV_PDU_SHORT then
  searchVector.rembus = 0
  searchVector.msgid = tlv.word64[5] & 0x0000000000FFFFFF
  noSearch = false
-- AVBTP L-PDU multiplex input with CAN ID
elseif tlv.messageType == CLF_TLV_P1722_CAN then
  searchVector.rembus = tlv.rembus
  searchVector.msgid = tlv.word64[4] & 0x000000001FFFFFFF
  noSearch = false
-- AVBTP L-PDU multiplex input with CAN ID
elseif tlv.messageType == CLF_TLV_P1722_CAN_BRIEF then
  searchVector.rembus = tlv.rembus
  searchVector.msgid = tlv.word64[4] & 0x000000001FFFFFFF
  noSearch = false
-- AVBTP L-PDU multiplex input with LIN ID
elseif tlv.messageType == CLF_TLV_P1722_LIN then
  searchVector.rembus = tlv.rembus
  searchVector.msgid = tlv.word64[4] & 0x3F
  noSearch = false
-- AVBTP General Purpose control message
elseif tlv.messageType == CLF_TLV_P1722_GPC
  searchVector.rembus = 0
  searchVector.msgid = 0
  noSearch = true
else
  skipCount = skipCount + 1
  noSearch = true
  validMsg=true
end
******** Pseudocode 1 - END *******
```

In further exemplary embodiments, the “noSearch” variable provided in the above pseudocode 1 can characterize whether or not a search is to be performed by the searching device E1. In further exemplary embodiments, the conditioning device E4 can transmit the information associated with the noSearch variable to the searching device E1, cf., for example, arrow a3 according to FIG. 18.

In further exemplary embodiments, the “validMsg” variable provided in the above pseudocode 1 can be used to be able to distinguish between valid and invalid messages or data frames.

In further exemplary embodiments, the query “-- AVBTP General Purpose control message elseif tlv.messageType==CLF_TLV_P1722_GPC” contained in the above pseudocode 1 can have the effect that no search is performed for a PDU identifier of the format/type AVBTP or CLF_TLV_P1722_GPC. For example, in further exemplary embodiments, a configurable connection identifier VB-ID-CFG (cf., for example, block 226 according to FIG. 12) can be specified for such types of PDU identifiers, i.e., for example, without a preceding search.

In further exemplary embodiments, it can be provided that a or the configurable connection identifier VB-ID-CFG is used for PDU identifiers for which no search is performed.

In further exemplary embodiments, it is provided that the apparatus 100b comprises a device E7 for modifying header data, which device is designed, for example, to selectively discard a protocol data unit PDU-1, for example on the basis of a control a4 by the searching device E1, for example if the search by the searching device E1 has not produced a result.

In further exemplary embodiments, the apparatus 100b comprises a third buffer memory E8, which can at least temporarily buffer protocol data units to be output and can, optionally, at least temporarily perform a segmentation.

In further exemplary embodiments, the apparatus 100b comprises a statistics device E9, which is designed to ascertain or to manage statistical information with respect to an operation of the apparatus 100, 100a, 100b or of the searching device E1.

In further exemplary embodiments, the apparatus 100b, e.g., the statistics device E9, is designed to manage at least one of the following counters, FIG. 19, mentioned by way of example: a) counter Z1 for a number of discarded protocol data units, b) counter Z2 for a total number of protocol data units processed by the apparatus 100, 100a, 100b, c) counter Z3 for a number of protocol data units forwarded by means of the apparatus 100, 100a, 100b, d) counter Z4 for a number of search hits of the searching device E1, e) counter Z5 for a number of unsuccessful searches by means of the searching device E1, f) counter Z6 for protocol data units to be discarded, which are, for example, damaged, for which the conditioning device E4, for example, indicates that they are to be discarded, for example with the exception of protocol data units of the type AVB P1722 GPC, g) counter Z7 for a number of bytes that have been transmitted by the apparatus 100, 100a, 100b.

In further exemplary embodiments, at least one of the aforementioned counters Z1, Z2, . . . , Z7 has a data width of 32 bits, which in further exemplary embodiments, for example, enables comparatively low-frequency polling (e.g., every second or less often than once per second), for example by means of software, for example by means of the software component 134 (FIG. 7).

In further exemplary embodiments, a design of the searching device E1 (FIG. 18) can depend on a search algorithm used.

In further exemplary embodiments, the following exemplary embodiments for the search algorithm are possible, wherein both of the following exemplary embodiments are variants of, for example, a binary search and use, for example, a work table E2 (FIG. 18) and a shadow table E3.

In further exemplary embodiments, the work table E2 is, for example, used by the hardware component 132 (FIG. 7), for example for performing 200 the search (FIG. 9) and/or for ascertaining 202 a connection identifier VB-ID-1 associated with the received protocol data unit PDU-1.

In further exemplary embodiments, the shadow table E3 is, for example, used by the software component 134, for example for changing the lookup table, for example if entries are added and/or removed, for example during a runtime of the apparatus 100, 100a 100b.

In further exemplary embodiments, a binary sorted table can, for example, be used, which comprises, for example, a sorted plurality (“array”) of reference vectors, e.g., the aforementioned reference vectors. In further exemplary embodiments, each entry of the binary sorted table can, for example, be referred to as a node.

In further exemplary embodiments, a search tree, e.g., a balanced search tree, e.g., a red-black tree, can, for example, be used, see, for example, the above description of the first search tree B-1 and the second search tree B-2. In further exemplary embodiments, at least one of the search trees B-1, B-2 can, for example, be organized in the form of a table.

In further exemplary embodiments, a node structure for the at least one search tree B-1, B-2 can, for example, be characterized according to:

```
node = {
  refVector = {
    rxbus (8 bit)
    rembus (8 bit)
    msgid (32 bit)
  }
  attrib = {
    tlv = {
        pduCid (log2(entries) bit)
        canpad (4 bit)
        color(1 bit)
        modcmd (2 bit)
        modparam (11 bit) }
      sec = { secGen (1 bit) secChk (1 bit) }
      fw (1 bit)
      nodeLeft (log2(entries) bit)
      nodeRight (log2(entries) bit)
      } ,
```

wherein refVector characterizes a reference vector, wherein the reference vector can, by way of example, comprise the elements rxbus (with, for example, 8 bits), rembus (with, for example, 8 bits), msgid (with, for example, 32 bits) already described above,
wherein attrib characterizes optional attributes for a node,
wherein sec characterizes attributes associated with a possible authentication,
wherein fw characterizes an optional attribute that indicates whether a, for example optional, security check is to be performed, for example by means of the checking device 125, E10, e.g., the firewall, for a relevant protocol data unit or for protocol data units associated with a connection identifier pduCid,
wherein nodeLeft characterizes the left child node in the binary search tree,
wherein nodeRight characterizes the right child node in the binary search tree, and
wherein color characterizes a color attribute for the search tree.

In further exemplary embodiments, a binary search tree, e.g., a binary search tree that can be stored or is stored in a hardware memory, can, for example, comprise the component “color.” The latter can be used in further exemplary embodiments to be able to modify the search tree, for example “in memory” (i.e., for example, directly in the memory), for example without having to create a, for example expensive, copy in the working memory of the software.

In further exemplary embodiments, the search tree that can be evaluated by the hardware component 132, e.g., the first search tree B-1, comprises no color information (red-black) for its nodes. In further exemplary embodiments, this color information (red-black) is, for example, provided and/or used if nodes are added and/or removed, which operations are, for example, performed on the second search tree B-2, for example by means of the software component 134. In further exemplary embodiments, the color information (red-black) associated with the nodes of the second search tree B-2 can thus, for example, be kept or at least temporarily stored in a table that can be managed by means of the software component 134.

In further exemplary embodiments, the search tree that can be evaluated by means of the hardware component 132, e.g., the first search tree B-1, comprises color information (e.g., red-black) for its nodes, which can, for example, be realized by means of the aforementioned “color” component.

The aforementioned exemplary embodiments on the basis of a binary search advantageously require a comparatively small search effort, since it is logarithmic, on the basis of the total number of elements of the relevant search tree or the relevant table.

In further exemplary embodiments, it is provided that, in the event of a successful search 200 (FIG. 9), the searching device E1 transmits the optional attributes attrib for the node found in the search 200, for example of the search tree B-1, to the device E7 for modifying header data, cf. arrow a5 according to FIG. 18. In this case, no discarding of the relevant protocol data unit PDU-1 is signaled, for example, cf. arrow a4 already described above with reference to FIG. 12.

In further exemplary embodiments, it is provided that, in the event of an unsuccessful search 200, the searching device E1 performs at least one of the following actions: a) instructing the device E7, for example by means of arrow a4, to discard the protocol data unit PDU-1 (wherein the counter Z6, FIG. 19, can also be incremented, for example), b) inserting a, for example static and/or configurable, connection identifier VB-ID-CFG (and/or setting a firewall flag fw, which indicates that the protocol data unit PDU-1 is to be subjected to a security check, for example by the firewall device 125, E10).

In further exemplary embodiments, it is provided that a data structure, e.g., a node structure, for the at least one search tree B-1, B-2, see, for example, the “node” structure already described by way of example above, comprises an attribute that indicates whether a security check, for example by means of the checking device 125, E10, is to be performed for a relevant protocol data unit or for protocol data units associated with a connection identifier. For example, the attribute may be characterized by the aforementioned bit flag “fw” and/or correspond to the first item of information I1 or the first item of control information SI-1 (FIG. 1).

In further exemplary embodiments, it is provided that the checking device 125 (FIG. 1) is designed to use the connection identifier VB-ID, for example for ascertaining a service and/or an identification associated with, for example, the at least one received protocol data unit.

Further exemplary embodiments, FIG. 2, relate to a method, e.g., a computer-implemented method, for processing data units PDU-1, e.g., protocol data units, for an apparatus 100, 100a, 100b, for example according to the embodiments, comprising a first number 110 of input interfaces for receiving protocol data units and, optionally, a second number 120 of output interfaces for outputting protocol data units, and a checking device 125, e.g., a firewall device, which is designed to check at least one received protocol data unit, e.g., to subject it to a security check, wherein the method comprises: receiving 10 (FIG. 2) at least one protocol data unit PDU-1, checking 12 the received at least one protocol data unit PDU-1 by means of the checking device 12.

In further exemplary embodiments, it is provided that the method comprises at least one of the following elements: a) outputting 14 the at least one protocol data unit, for example on the basis of the test 12, b) discarding 15 the at least one protocol data unit, for example on the basis of the test 12.

In further exemplary embodiments, it is provided that the checking device 125 modifies or influences the at least one received protocol data unit and/or an output of the at least one received protocol data unit, for example via an output interface.

Further exemplary embodiments, FIG. 21, relate to an apparatus for performing the method according to the embodiments. In further exemplary embodiments, the apparatus can, for example, have at least one of the configurations 100, 100a, 100b already described by way of example above with reference to FIGS. 1, 7, 18.

In further exemplary embodiments, the apparatus can alternatively or additionally also have the configuration 300 shown by way of example in FIG. 21 or a configuration similar thereto.

The apparatus 300 comprises: a computing device (“computer”) 302 comprising at least one computing core 302a, 302b, 302c, a memory device 304, allocated to the computing device 302, for at least temporarily storing at least one of the following elements: a) data DAT, b) computer program PRG, in particular for performing the method according to the embodiments. In further exemplary embodiments, a computing core 302c can, for example, also be designed or modified to realize the function of the firewall, or, as an alternative to a further computing core, the apparatus 300 can comprise a hardware circuit 302c that realizes the firewall 125, which circuit can also be provided outside the computing device 302 in further embodiments (not shown). The same applies to the hardware component 132 in further exemplary embodiments.

The optional elements 325, 332 according to FIG. 21 respectively symbolize, by way of example, a hardware firewall 325 or hardware component 332, for example comparable to components 132, 125.

In further exemplary embodiments, the memory device 304 comprises a volatile memory (e.g., a working memory (RAM)) 304a and/or a non-volatile memory (e.g., a flash EEPROM) 304b, or a combination thereof or with other memory types not explicitly mentioned.

In further exemplary embodiments, the data DAT can at least temporarily comprise at least one received protocol data unit PDU-1 and/or at least a portion of at least one search tree B-1, B-2, and/or associated information, e.g., color information characterizing red-black attributes of the second search tree B-2.

In further exemplary embodiments, at least one of the buffer memories E5, E6, E8 according to FIG. 18 can, for example, be realized by means of the memory device 304 or the RAM 304a.

In further exemplary embodiments, the apparatus 300 comprises at least one data interface 306 for receiving and/or transmitting data, e.g., protocol data units. In further exemplary embodiments, at least some of the input interfaces 110 (FIG. 1) and/or of the output interfaces 120 can, for example, be realized by means of the data interface 306.

Further exemplary embodiments relate to a computer-readable storage medium SM comprising instructions that, when executed by a computer 302, cause the latter to perform the method according to the embodiments.

Further preferred embodiments relate to a computer program PRG comprising instructions that, when the program PRG is executed by a computer 302, cause the latter to perform the method according to the embodiments.

Further exemplary embodiments relate to a data carrier signal DCS, which characterizes and/or transmits the computer program PRG according to the embodiments. The data carrier signal DCS can, for example, be transmitted via the data interface 306 of the apparatus 300.

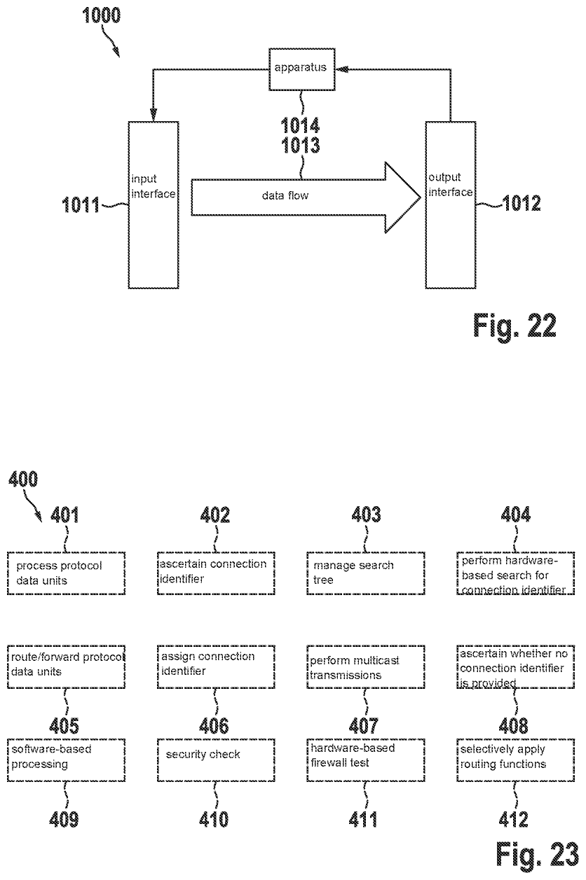

In further exemplary embodiments, the apparatus 100, 100a, 100b, 300 can, for example, be used for or in an automotive gateway 1000, FIG. 22, i.e., a gateway for applications in the field of automotive engineering, wherein, for example for incoming protocol data units PDU-1 at the apparatus, a respective connection identifier VB-ID-1 can be ascertained, for example by means of hardware, and wherein, optionally, on the basis of the ascertained connection identifier VB-ID-1, the incoming protocol data units PDU-1 can be output, for example. Optionally, a hardware firewall 125 may subject at least some of the incoming protocol data units PDU-1 to a hardware-based security check.

In further exemplary embodiments, the input interfaces 110 and/or the output interfaces 120 can, for example, respectively also comprise at least one virtual interface, for example in contrast to a physical interface.

In further exemplary embodiments, a virtual interface can be characterized in that individual data units, e.g., protocol data units, for example as a so-called “contained PDU,” are, for example, present in an Ethernet or UDP packet, e.g., a so-called “container PDU.” In further exemplary embodiments, the contained PDUs can be extracted from the container PDU, for example by means of a packet parser.

In further exemplary embodiments, a common data format or message format, for example for processing incoming protocol data units PDU-1, can be used by the apparatus according to the embodiments, for example independently of a respective type (e.g., L-PDUs, I-PDUs, N-PDUs, S-PDUs) of the incoming protocol data units PDU-1, with the possibility of an efficient hardware-based firewall check at the same time.

In further exemplary embodiments, the received protocol data units PDU-1 are provided, for example on the basis of the search 200 (FIG. 9) or the ascertainment 202, with a connection identifier VB-ID-1, which is, for example, independent of the protocol or of a respective type (e.g., L-PDUs, I-PDUs, N-PDUs, S-PDUs) of the incoming protocol data units PDU-1 and on the basis of which, for example, a firewall check and/or, where applicable, routing, e.g., forwarding, of the protocol data units PDU-1 can be performed by the apparatus or in the apparatus, for example to one or more (multicast) output interfaces.

In further exemplary embodiments, a modification of the PDU identifier PDU-ID can be selectively performed.

In further exemplary embodiments, unknown protocol data units (for which the search 200 or the ascertainment 202 was, for example, negative and thus did not lead to a connection identifier associated with the PDU identifier PDU-ID) can be processed further, for example by means of the software component 134, for example by a computer program that can be provided for this purpose and performs, for example, a detailed analysis of the unknown protocol data unit or a security analysis, and/or by means of the firewall 125.

In further exemplary embodiments, the apparatus 100, 100a, 100b, 300 according to the embodiments can, for example, be used as a, for example unidirectional, feedback device for a gateway, e.g., for an automotive gateway 1000, cf. FIG. 22, wherein the apparatus 100, 100a, 100b, 300 is, for example, designed to receive protocol data units PDU-1 from at least one output interface 1012 of the gateway 10 and to optionally supply the protocol data units PDU-1 to at least one input interface 1011 of the gateway 10. Advantageously, the apparatus 100, 100a, 100b, 300 can perform the above-described firewall check for at least some protocol data units PDU-1. For example, block 1014 in FIG. 22 can have the configuration 100, 100a, 100b, 300 according to the embodiments described by way of example above. Block arrow 1013 symbolizes a data flow in the gateway 1000, for example from the input interface 1011 to the output interface 1012, as is, for example, associated with a processing pipeline of the gateway 1010.

In further exemplary embodiments, the apparatus 100, 100a, 100b, 300 is designed to receive data units, e.g., complete data units, e.g., protocol data units, for example one after the other in time (in a “serialized” manner), for example from a component of the at least one output interface 1012 of the gateway 1000.

In further exemplary embodiments, the apparatus 100, 100a, 100b, 300 is designed to output protocol data units to be output, in the same format as they were received. In further exemplary embodiments, the apparatus 100, 100a, 100b, 300 is designed to insert a connection identifier, ascertained, for example, on the basis of the search 200, into a received protocol data unit PDU-1. In further exemplary embodiments, the apparatus 100, 100a, 100b, 300 is designed to insert a (for example set) firewall flag (fw, see above), e.g., on the basis of an ascertained connection identifier, into a received protocol data unit PDU-1, whereby, in further exemplary embodiments, the firewall 125 can be notified that it is to perform a check of the relevant protocol data unit PDU-1.

In further exemplary embodiments, the apparatus 100, 100a, 100b, 300 is designed to change a type, e.g., a message type, of a received protocol data unit PDU-1.

In further exemplary embodiments, the apparatus 100, 100a, 100b, 300 is designed to change, e.g., correct, a length of a received protocol data unit PDU-1, for example in the case of received padded data units associated with CAN-FD data frames, for example. In further exemplary embodiments, this can, for example, be useful if the received protocol data unit PDU-1 is to be forwarded to another output interface (other than, for example, of the CAN-FD type), for example with its actual length (and not, for example, the length caused by the padding).

In further exemplary embodiments, the apparatus 100, 100a, 100b, 300 is designed to load a table associated with the at least one search tree B-1, B-2 or characterizing the at least one search tree B-1, B-2, e.g., to load it dynamically, i.e., during an operation of the apparatus, wherein the loaded data DAT can, for example, be stored at least temporarily in the memory device 304. In further exemplary embodiments, the second search tree B-2 can thus, for example, be loaded, for example externally, into the apparatus and, at a specifiable point in time, for example during a reset of the apparatus, the content of the second search tree B-2 can be transmitted to the first search tree B-1 so that, from then on, the first search tree B-1 can be used with the new content based on the loaded second search tree B-2, for example for the hardware-based search 200.

In further exemplary embodiments, the apparatus 100, 100a, 100b, 300 can selectively, for example, use a search tree B-1 or a first search tree B-1 and a second search tree B-2 or corresponding tables, wherein a memory region available for the search tree(s) or the corresponding tables can, for example, be used in some exemplary embodiments for a search tree B-1 or a table, wherein the memory region available for the search tree(s) or the corresponding tables can, for example, be used in further exemplary embodiments for both search trees B-1, B-2 or corresponding tables so that, for example in the case of two search trees, approximately half the storage capacity results for each search tree in comparison to the case of a single search tree B-1.

In further exemplary embodiments, the first buffer memory E5 (FIG. 18) can, for example, be used for a rate adaptation, i.e., for example, for an adaptation of a rate at which received protocol data units PDU-1 are output via at least one output interface 120a of the second number of output interfaces 120 and/or at which received protocol data units PDU-1 are checked by means of the firewall 125, where applicable prior to the optional output. In further exemplary embodiments, the rate can, for example, be controlled 261 or regulated 262 (FIG. 17).

In further exemplary embodiments, both a rate at which protocol data units are received from the gateway 1000 or its output interface 1012 and a rate at which protocol data units are transmitted to the gateway 1000 or its input interface 1012 can be specified, for example by the processing pipeline 14.

In further exemplary embodiments, the apparatus 100, 100a, 100b, 300 is designed to receive incoming protocol data units, for example in the form of “bursts,” i.e., intermittently, and/or to check them by means of the firewall 125.

In further exemplary embodiments, the searching device E1 is designed to work at a non-constant rate with respect to a processing (e.g., search) because, for example, individual searches 200 for different received protocol data units, for example in the first search tree B-1, can, for example, have durations of different lengths.

In further exemplary embodiments, a security check 12 that can optionally or selectively be activated or performed for individual protocol data units, for example by the firewall device 125, E10, can also lead to a non-constant processing rate for protocol data units.

In further exemplary embodiments, such a possibly non-constant processing rate can be compensated, or adjusted to a specifiable rate, at least partially, for example by using at least one of the buffer memories E5, E6, E8.

In further exemplary embodiments, the first buffer memory E5 is designed to output status information a6, for example to a component 1012 of the gateway 1000 providing the protocol data units PDU-1, which, for example, indicates that a, for example configurable, first fill level of the first buffer memory E5 has been reached. In further exemplary embodiments, the first buffer memory E5 is designed to no longer output the status information a6, for example if the, for example configurable, first fill level (or a specifiable second fill level, which can be different from the first fill level, for example for achieving a hysteresis) of the first buffer memory E5 is undershot again.

In further exemplary embodiments, data units, e.g., protocol data units, reach the apparatus 100 or the checking device 125, E10, e.g., the firewall device 125, E10, via different link layers (e.g., connection levels), some of which are listed below by way of example:

### Case 1: Ethernet and/or IP/UDP Container

Here, protocol data units are, for example, multiplexed into user datagram protocol, UDP, container packets.

### Case 2: CAN Container

Here, protocol data units are, for example, multiplexed into a CAN container data frame (“frame”).

### Case 3: CAN/LIN Bus

Here, a received CAN or LIN data frame, e.g., a frame, carries, for example precisely, one protocol data unit.

In further exemplary embodiments, e.g., in the aforementioned case 1 and/or 2, the checking device 125, E10 can be designed to perform a check on at least one of the layers 2 to 4 of the ISO/OSI reference model (e.g., “layer 2-4 firewall”).

In further exemplary embodiments, e.g., in the aforementioned case 1 and/or 2, at least one frame filter, e.g., filter for data frames, can be provided, for example a layer 2 frame filter that considers or tests or filters, for example only, the container.

In further exemplary embodiments, the function of the filter for data frames, e.g., of the layer 2 frame filter, can be realized by the checking device 125, E10. In further exemplary embodiments, the function of the filter for data frames, e. g., of the layer 2 frame filter, can also be realized by at least one component other than the checking device 125, E10.

In further exemplary embodiments, the checking device 125, E10 checks, for example only, the “contained” PDUs, i.e., the protocol data units contained in the respective container.

In further exemplary embodiments, the layer 2-4 firewalls/frame filters and a layer 5 firewall function, as can be achieved, for example, by the checking device 125, E10, are linked, whereby an effective deep packet inspection can, for example, be realized in further exemplary embodiments.

In further exemplary embodiments, the layer 2 (or layer 2-4) firewalls, for example, produce a first identification, e.g., a so-called TCAMID, for example as a result of the L2 lookup for the container, i.e., for example, on the basis of a test of a container in the protocol layer 2.

In further exemplary embodiments, the first identification, e.g., TCAMID, is, for example, passed on to all PDUs contained in a relevant container, e.g., is copied into the PDU header.

In further exemplary embodiments, the layer 5 firewall function, as can be realized, for example, by the checking device 125, E10, can, for example, link its, for example local, check result (for layer 5, “L5”) to the result of the L2-L4 firewall.

In further exemplary embodiments, a deep packet inspection of layer 2 to layer 5 can, for example, be performed by the procedure described by way of example above.

In the above-described exemplary case 2 of a CAN container, in which protocol data units are, for example, multiplexed into a CAN container data frame (“frame”), a frame filter that, for example, evaluates or tests CAN IDs can be provided in further example embodiments.

In the aforementioned exemplary case 1 (Ethernet and/or IP/UDP container), a ternary content addressable memory (TCAM), which evaluates packet contents of at least one of the layers 2 to L4, can, for example, be used in further exemplary embodiments.

Further exemplary embodiments, FIG. 23, relate to a use 400 of the apparatus according to the embodiments and/or of the method according to the embodiments and/or of the computer-readable storage medium according to the embodiments and/or of the computer program according to the embodiments and/or of the data carrier signal according to the embodiments and/or of the gateway according to the embodiments for at least one of the following elements: a) processing 401 data units, e.g., protocol data units, for example of a vehicle, e.g., a motor vehicle, b) ascertaining 402, e.g., searching for, for example by means of a hardware component, a connection identifier associated with a received protocol data unit, c) managing 403 at least one search tree, d) performing 404 a hardware-based search for a connection identifier for a data unit, e.g., a protocol data unit, for example for a gateway for automotive applications, wherein the search can, for example, be performed with logarithmic effort, e) routing 405 or forwarding data units, e.g., protocol data units, for example of a vehicle, e.g., a motor vehicle, wherein the data units can, for example, be of different types, f) assigning 406 a, for example protocol-independent, connection identifier, g) performing 407 multicast transmissions, h) ascertaining 408 whether no connection identifier is provided, e.g., stored, e.g., contained in the search tree, for a specifiable received data unit, e.g., a protocol data unit, i) software-based processing 409 of a received data unit, e.g., a protocol data unit, for which no connection identifier is provided, e.g., stored, e.g., contained in the search tree, j) checking 410 the at least one received protocol data unit PDU-1, e.g., performing 12 a security check, k) hardware-based firewall test 411 of protocol data units associated with at least one protocol, e.g., at least one service-oriented protocol, which works in layer 5 of the ISO/OSI reference model, e.g., protocol data units associated with a scalable service-oriented middleware over IP, SOME/IP, protocol, l) selectively applying 412 routing functions, e.g., forwarding functions, and/or 10 firewall functions to protocol data units.

1-31. (canceled)

32. An apparatus for processing data units, comprising:
a first number of input interfaces configured to receive protocol data units; and
a checking device configured to check at least one received protocol data unit.

33. The apparatus according to claim 32, further comprising:
a second number of output interfaces configured to output protocol data units.

34. The apparatus according to claim 32, wherein the checking device is a hardware circuit.

35. The apparatus according to claim 32, wherein the checking device is configured to selectively test the at least one received protocol data unit based on a first item of control information.

36. The apparatus according to claim 32, wherein the checking device is configured d to test at least some received protocol data units.

37. The apparatus according to claim 32, wherein the checking device is configured to check protocol data units associated with at least one protocol which works in layer 5 of an ISO/OSI reference model.

38. The apparatus according to claim 32, wherein the checking device is configured to ascertain a message type of at least one SOME/IP message associated with the at least one received protocol data unit, wherein the message type includes at least one of the following elements: a) REQUEST, b) REQUEST_NO_RETURN, c) NOTIFICATION, d) RESPONSE, e) ERROR, f) TP_REQUEST, g) TP_REQUEST_NO_RETURN, h) TP_NOTIFICATION, i) TP_RESPONSE, j) TP_ERROR.

39. The apparatus according to claim 32, wherein the checking device is configured to ascertain a service type at least one SOME/IP message associated with the at least one received protocol data unit, wherein the service type includes at least one of the following elements: a) remote procedure call (RPC), b) Fire & Forget, c) Notify.

40. The apparatus according to claim 32, wherein the checking device is configured to perform a condition-based and/or condition-oriented evaluation of at least one SOME/IP service based on the at least one received protocol data unit.

41. The apparatus according to claim 32, wherein the checking device is configured to discard the at least one received protocol data unit.

42. The apparatus according to claim 32, wherein the checking device is configured to modify or to influence: the at least one received protocol data unit and/or an output of the at least one received protocol data unit.

43. The apparatus according to claim 32, wherein the checking device is configured to perform at least one of the following elements: a) attack detection, b) labeling the at least one received protocol data unit based on the check and/or based on a result of the check, c) outputting and/or forwarding the at least one received protocol data unit using a multicast mechanism for a further evaluation or performance of an attack detection, d) outputting and/or forwarding the at least one received protocol data unit using a unicast mechanism for a further evaluation or performance of an attack detection, e) ascertaining and/or evaluating messages for service detection, f) ascertaining and/or evaluating a protocol data unit of an AUTOSAR I-PDU type, for a security check.

44. The apparatus according to claim 32, wherein the apparatus further comprises:
a processing device which is configured to perform, based on a PDU identifier associated with a received protocol data unit, a search in at least a first search tree including an allocation of in each case one PDU identifier to a connection identifier characterizing at least one data connection, wherein the search can be performed before and/or after and/or with an at least partial time overlap with the check.

45. The apparatus according to claim 44, wherein the apparatus is configured to ascertain, based on the received protocol data unit, a connection identifier associated with the received protocol data unit, wherein the ascertainment can be performed before and/or after and/or after and/or with an at least partial time overlap with the check.

46. The apparatus according to claim 45, wherein the processing device includes at least one hardware component configured to perform the search in the first search tree and/or to ascertain the connection identifier associated with the received protocol data unit.

47. The apparatus according to claim 44, wherein the first search tree is a binary tree.

48. The apparatus according to claim 44, wherein the processing device includes at least one software component, wherein the software component is configured to perform at least one of the following elements: a) at least temporarily forming the first search tree, b) at least temporarily modifying the first search tree, c) receiving the at least one protocol data unit from the checking device, d) performing a software-based, attack detection.

49. The apparatus according to claim 48, wherein the at least one software component is configured to perform a specifiable response if no connection identifier associated with the received protocol data unit can be ascertained for the received protocol data unit because no connection identifier associated with the received protocol data unit is present for the received protocol data unit in the first search tree, wherein the specifiable response includes at least one of the following elements: a) discarding the received protocol data unit, b) assigning a configurable connection identifier to the received protocol data unit, c) setting or inserting a first item of information or a first item of control information for the received protocol data unit, wherein the first item of information and/or the first item of control information indicates that the received protocol data unit is to be subjected to a check.

50. The apparatus according to claim 32, further comprising at least one memory configured to at least temporarily store one or more protocol data units or portions of one or more protocol data units.

51. The apparatus according to claim 32, further comprising a conditioning device configured to change a PDU identifier associated with a received protocol data unit.

52. The apparatus according to claim 32, wherein a node structure for the first search tree includes an attribute that indicates whether a security check is to be performed for a relevant protocol data unit or for protocol data units associated with a connection identifier.

53. The apparatus according to claim 44, wherein the checking device is configured to use the connection identifier for ascertaining a service and/or an identification associated with the at least one received protocol data unit.

54. A computer-implemented method for processing data units, for an apparatus including a first number of input interfaces configured to receive protocol data units, and a checking device configured to check at least one received protocol data unit, the method comprising:
receiving at least one protocol data unit; and
checking the received at least one protocol data unit using the checking device.

55. The method according to claim 54, further comprising at least one of the following steps: a) outputting the at least one protocol data unit based on the check, b) discarding the at least one protocol data unit based on the check.

56. The method according to claim 54, wherein the checking device modifies or influences the at least one received protocol data unit and/or an output of the at least one received protocol data unit via an output interface.

57. The method according to claim 54, wherein the checking device performs at least one of the following elements: a) attack detection, b) labeling the at least one received protocol data unit based on the check and/or based on a result of the check, c) outputting and/or forwarding the at least one received protocol data unit by a multicast mechanism to at least one software component for further evaluation or performance of a software-based, attack detection, d) outputting and/or forwarding the at least one received protocol data unit by a unicast mechanism to the at least one software component for further evaluation or performance of a software-based, attack detection, e) ascertaining and/or evaluating messages for service detection, which are based on a connectionless, network protocol, f) ascertaining and/or evaluating protocol data units of the AUTOSAR I-PDU type for a security check.

58. An apparatus for processing data units, for an apparatus including a first number of input interfaces configured to receive protocol data units, and a checking device configured to check at least one received protocol data unit, the apparatus for processing data units configured to:
receive at least one protocol data unit; and
check the received at least one protocol data unit using the checking device.

59. A non-transitory computer-readable storage medium on which are stored instructions for processing data units, for an apparatus including a first number of input interfaces configured to receive protocol data units, and a checking device configured to check at least one received protocol data unit, the instructions, when executed by a computer, causing the computer to perform the following steps:
receiving at least one protocol data unit; and
checking the received at least one protocol data unit using the checking device.

60. An automotive gateway, comprising:
at least one apparatus for processing data units, including:
a first number of input interfaces configured to receive protocol data units, and
a checking device configured to check at least one received protocol data unit.

61. The apparatus according to claim 32, wherein the apparatus us used for at least one of the following elements: a) processing protocol data units a motor vehicle, b) searching for, using a hardware component, a connection identifier associated with a received protocol data unit, c) managing at least one search tree, d) performing a hardware-based search for a connection identifier for a protocol data unit for a gateway for an automotive application, e) routing or forwarding protocol data units of a motor vehicle, wherein the protocol data units can be of different types, f) assigning a protocol-independent connection identifier, g) performing multicast transmissions, h) ascertaining whether no connection identifier is provided in the search tree for a specifiable received protocol data unit, i) software-based processing of a received protocol data unit for which no connection identifier is contained in the search tree, j) checking the at least one received protocol data unit including performing a security check, k) hardware-based firewall test of protocol data units associated with at least one protocol, l) selectively applying routing functions including forwarding functions and/or firewall functions to protocol data units.
